(19) United States
(12) Patent Application Publication
(10) Pub. No.: US 2024/0097523 A1
(43) Pub. Date: Mar. 21, 2024

(54) LIQUID COOLED ELECTRIC MOTOR

(71) Applicant: ABB Schweiz AG, Baden (CH)

(72) Inventor: Giulio Secondo, Genova (IT)

(21) Appl. No.: 18/263,987

(22) PCT Filed: Feb. 11, 2022
(86) PCT No.: PCT/EP2022/053324

§ 371 Date: Aug. 2, 2023

(30) Foreign Application Priority Data
Feb. 12, 2021 (EP) 21156791.2

(51) Int. Cl. H02K 5/20; H02K 9/193

(52) U.S. Cl. CPC H02K 5/203; H02K 9/193; H02K 2209/00

(57) ABSTRACT

The present disclosure relates to an electric motor provided with liquid cooling means to avoid overheating. The electric motor includes a frame that develops along a longitudinal axis, a first and a second endshield connected at opposite ends of the frame, a stator assembly, and a rotor assembly, wherein the stator assembly is arranged, at least partially, in a longitudinal cavity of the frame and wherein the rotor assembly is arranged, at least partially, in a longitudinal space defined by the stator assembly and supported, at opposite ends, by the endshields so as to rotate about the longitudinal axis. The electric motor further includes liquid cooling means to dissipate the heat generated during the operation of the electric motor. The cooling means include a plurality of circulation channels defined through the frame for the circulation of a cooling fluid, and at least one hydraulic connecting channel.

### CROSS REFERENCE TO RELATED APPLICATIONS

This patent application is a National Stage Entry of PCT/EP2022/053324 filed on Feb. 11, 2022, which claims the benefit and priority of European Patent Application No. 21156791.2 filed on Feb. 12, 2021, the disclosures of which are incorporated by reference herein in their entirety as part of the present application.

### BACKGROUND

The present disclosure refers to the field of manufacturing of rotary electric machines, in particular rotary electric motors. More precisely, the present disclosure relates to an electric motor provided with liquid cooling means to avoid overheating.

An electric motor is an electrical machine able to convert electrical energy into mechanical energy. More precisely an electric motor produces a linear or a rotary force (torque) which is transferred to an external device, system, or mechanism by a mechanical connection. The electric motors are classified in two main groups: linear motors and rotary motors. As known, a rotary electric motor typically includes a hollow frame that develops along a longitudinal axis so as to define a longitudinal cavity inside which an annular stator assembly is arranged. A first endshield and a second endshield are rigidly fixed to the frame at opposite end thereof. A rotor is supported by the two endshields at its opposite ends so as to rotate coaxially and internally to the stator.

According to a first known solution, an electric motor is provided with air cooling means including an axial fan arranged inside a cavity defined in one of the two endshields. The axial fan is mounted on the rotor shaft at one end opposite to the one used to transfer the mechanical torque to an external device or system. The frame is provided with axial fins protruding outwards in order to increase the exchange surface useful to dissipate heat generated during the operation of the electric motor. The air motion is induced by the rotation of the rotor. Indeed, following such a rotation, the axial fan blows up air on the outer surface of the frame so as to reduce its temperature by convention.

This solution is typically provided on constant speed electric motor. According to a different solution, usually installed on variable speed electric motors, an axial fan is arranged in a cavity of an endshield and operated independently from the rotor, by means of another motor. In this case, the air is usually blown up across the stator and/or frame axial channels. In some cases, the air may be blown also up on the rotor and the overhangs. In some known embodiments, the frame has a rectangular section, considered in a plane orthogonal to the rotor axis, and it is provided with axial channels each of which provided at a corresponding corner of the section.

As a fact, most of the electric motors on the market are air cooled. However, in some applications, for example in the field extrusion plastic processes wherein the use of air is a critical factor in terms of environmental cleanliness or whenever the noisiness has to be minimized, liquid cooled electric motors are preferred. Typically, water, glycol or oil are used as cooling fluids. According to a first known embodiment, the cooling is obtained by means of a liquid jacket or a coil pipe that surrounds the frame of the motor in which the stator and the rotor are arranged.

According to a further known embodiment, the liquid cooling system includes a plurality of pipes each of which inserted in a corresponding channel longitudinally defined through the frame of the electric motor. Overall, these pipes define a cooling circuit by means of which the cooling fluid subtracts heat from the frame. Indeed, the heat is transmitted from the frame to the pipes by conduction and then from the pipes to the cooling fluid by convection.

In order to allow the circulation along the pipes, the latter are mutually connected each other at their ends. On this regard, according to a known solution, the body of the endshields is machined so as to define a plurality of connecting channels each of which hydraulically connects two ends of different pipes. These channels are obtained close to the surface of the endshield addressed to be connected to the frame and their axis of development lay on a plane orthogonal to the longitudinal axis. These channels are connected to the pipes of the frame by means of axial holes defined longitudinally through the endshield body. The ends of two different pipes are inserted in two corresponding axial holes while appropriate hydraulic plugs are used to close the connecting channel at their end. Therefore, the cooling liquid exiting from a pipe can enter into the connecting channel that diverts it to another pipe. The hydraulic plugs avoid the liquid to exit from the connecting channel, i.e., from the endshield.

Usually, since the diameter of the connecting channels as well as the diameter of the pipes through the frame cannot be much increased, in order to guarantee a sufficient cooling effect, the motor is designed so as to have the highest number of them. This solution allows to increase the length of the hydraulic circuit so as to compensate the relatively low flow rate circulating along the pipes and connecting channels and imposed by their diameter. However, overall, this technical solution is particularly complex and is a critical aspect in terms of manufacturing times and of costs. Further, several sealing interfaces (e.g., O-Rings or other similar devices) have to be provided to guarantee the correct sealing between the different components in mutual contact. The higher the number of sealing interfaces, the higher is the complexity, the time needed to assemble and the risk of failure (e.g., an O-ring wrongly mounted or missing). This in turn requires an accurate sealing test after the whole assembling and a complex recovery procedure if the test goes wrong. Moreover, the pipes must be inserted by pressing them to achieve a good contact with the stator laminations. Alternatively, they can be easily inserted with small interference but this leads to a very poor heat conduction characteristic.

### BRIEF DESCRIPTION

Embodiments of the present disclosure provide a liquid cooled electric motor which makes it possible to overcome or mitigate the aforementioned problems of the known art.

One embodiment of the present disclosure provides a liquid cooled electric motor that allows to simplify the manufacturing of the endshields at least for what concerns the liquid fluid circulation therein.

Another embodiment of the present disclosure provides a liquid cooled electric motor that can be easily configurated, in terms of hydraulic cooling circuit, depending on the use and/or of the space available for its installation.

A further embodiment of the present disclosure provides a liquid cooled electric motor easy to manufacture at industrial level, at competitive costs with similar electric motors of the state of the art.

These embodiments of the present disclosure, together with other objects that will become evident from the following description and accompanying drawings, are achieved, according to the present disclosure, by a cooled electric motor, according to claim 1 and the related dependent claims set out below.

In a general definition, a liquid cooled electric motor, according to the disclosure, includes a frame that develops along a longitudinal axis, a first endshield and a second endshield connected at opposite ends of said frame, a stator assembly and a rotor assembly, wherein said stator assembly is arranged, at least partially, in a longitudinal cavity of said frame and wherein said rotor assembly is arranged in a longitudinal space defined by said stator assembly and supported, at opposite ends, by said endshields so as to rotate about said longitudinal axis, liquid cooling means to dissipate the heat generated during the operation of said electric motor, wherein said cooling means include a plurality of circulation channels defined through said frame for the circulation of a cooling fluid, and at least one hydraulic connecting channel for connecting hydraulically two of said circulation channels at one of said endshields.

The electric motor according to the present disclosure is characterized in that said hydraulically connecting channel includes at least a first section configured by the coupling of a collector element with a seat defined by one of said endshields.

According to an embodiment, said hydraulic connecting channel includes a second section and a third section wherein said first section is included between said second section and said third section, wherein said second section and said third section make said first section communicating with a corresponding of said circulation channels.

According to an example embodiment, the seat has a coupling surface that develops around said longitudinal axis, said collector being a ring-shaped body with an outer surface and an inner surface, wherein said outer surface couples with the coupling surface of the seat, wherein said outer surface and said coupling surface are shaped so as to configure the first section of said connecting channel following their coupling.

According to an example embodiment, said ring-shaped body includes a slot which develops from the outer surfaces along an angular sector around said longitudinal axis, wherein said first section of said hydraulic connecting channel is configured by the coupling surface of the seat and by the surfaces defining such at least one slot.

According an embodiment, said second section and said third section are defined by two cavities each of which communicates with at least one of said circulation channels, and wherein at least two of said cavities includes a corresponding opening that makes the corresponding cavities communicating with the first section of said hydraulic connecting channel.

The one of said endshields may include four cavities each of which communicates with at least one of said circulation channels, and wherein each of the cavities includes a corresponding opening at the coupling surface. The ring-shaped body is coupled with said seat so that the slot communicates with two of said cavities by the corresponding openings.

According to a possible embodiment, the ring-shaped body includes two slots symmetrically defined with respect to a diametral plane containing said longitudinal axis; when the ring-shaped body is coupled with the seat, a first slot hydraulically connects a first cavity with a second cavity while a second slot hydraulically connects a third cavity and the fourth cavity.

According to a possible embodiment of the ring-shaped body, the outer surface of said ring-shaped body includes a first portion and a second portion which are separated by said at least one slot, at least along the angular sector along which it develops; each of the portions includes at least a circumferential groove that develops for an angle of 360° around the longitudinal axis, wherein such groove accommodates a sealing element.

The first portion may be closer to the frame than said second portion and wherein said first portion includes two or more circumferential grooves each of which to accommodate a sealing element.

According to a possible embodiment, the frame has a rectangular shaped cross section, wherein said cross section is considered on a plane orthogonal to said longitudinal axis.

According to another embodiment, at least one of said endshields has a prismatic shape defined by four side external surfaces that develop on planes two by two parallel.

At least one of the endshields may include four external open cavities each of which defined at one of its corners, wherein each corner is identified by two external surfaces of the endshield, wherein the open cavities accommodate connecting means to connect said frame to the endshield and/or to connect a hydraulic connector to feed or to discharge the cooling fluid flowing in said circulation channels.

According to a possible embodiment, the frame is obtained by extrusion process and the circulation channels are defined during such extrusion process or alternatively the frame is obtained from a single casting piece as well as the circulation channels are obtained in the casting itself. The frame could be also obtained by means of a 3D printing process.

According to a further embodiment, said plurality of circulation channels includes a first couple, a second couple, a third couple, and a fourth couple of circulation channels wherein each of these couples is defined at a corresponding corner of said frame. For at least one of the couples of the circulation channels, the channels are symmetrically arranged with respect to a radial plane containing the longitudinal axis, wherein the radial plane is a symmetric plane also for the corresponding corner.

### BRIEF DESCRIPTION OF THE DRAWINGS

Further characteristics and advantages of the disclosure will emerge from the description of example, but not exclusive embodiments of an electric motor according to the present disclosure, non-limiting examples of which are provided in the attached drawings, wherein:

FIG. 1 is a first perspective view of an electric motor according to the present disclosure;

FIG. 1A is a partially exploded view of the electric motor of FIG. 1;

FIG. 2 is a second perspective view of the electric motor of FIG. 1;

FIG. 2A is a partially exploded of the electric motor of FIG. 2;

FIGS. 3 and 3A are section views respectively of a first terminal part and a second terminal part, opposite to the first one, of the electric motor of FIG. 1 according to the section plane of FIG. 1;

FIGS. 4 and 5 are a first section view and a second section view respectively according to section planes IV-IV and V-V of FIG. 2;

FIG. 6 is a further exploded view of the electric motor of FIG. 1;

FIG. 7 is a view of a first group of components of the electric motor of FIG. 1;

FIGS. 8 and 9 are views from different points of view of some components of the first group of FIG. 7;

FIGS. 10 and 11 are views from different points of view of a second group of components of the electric motor of FIG. 1;

FIG. 12 is a view of some components of the second group of FIGS. 10 and 11;

FIGS. 13 and 14 are respectively a prospective view and a section view of a first embodiment of a component of an electric motor according to the disclosure;

FIGS. 15 and 16 are respectively a prospective view and a section view of a second embodiment of said component of an electric motor according to the disclosure;

FIGS. 17A, 17B, and 17C are prospective view of the electric motor of FIG. 1 showing a first possible cooling mode thereof; and

FIGS. 18A and 18B are two prospective views of the electric motor of FIG. 2 showing a second possible cooling mode thereof.

### DETAILED DESCRIPTION

Referring to the above-mentioned Figures, the present disclosure relates to a liquid cooled electric motor 1, may be having a variable rotational speed. The electric motor 1 includes a frame 5 that develops along a longitudinal axis 500 and two endshields 10, 20 that are connected at opposite ends of the frame 5. The frame 5 may be defined by an extruded body made of metallic material, may be made of aluminum.

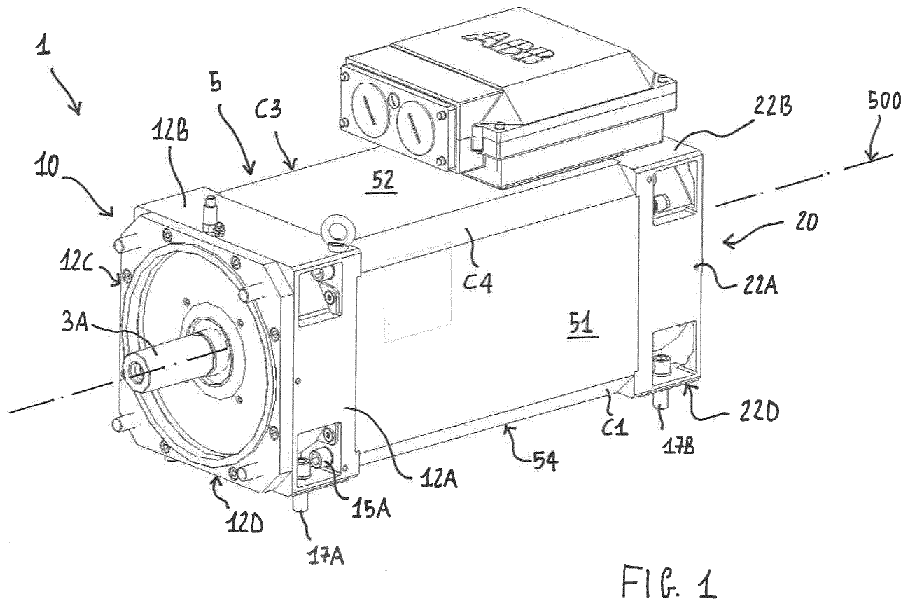

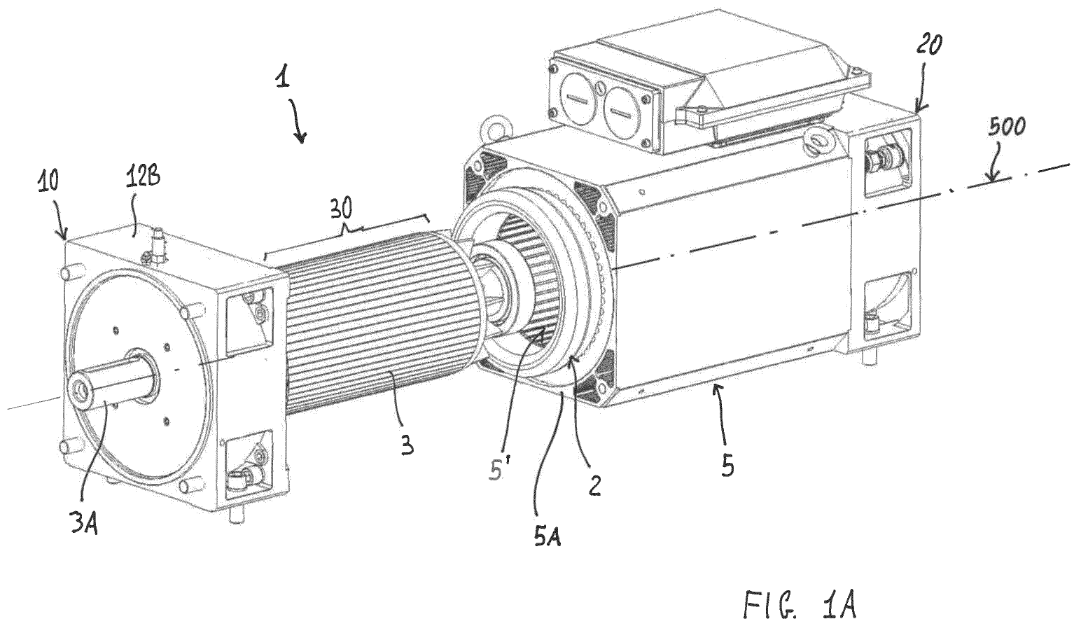

The frame 5 has a first end surface 5A and a second end surface 5B that develop orthogonally to the longitudinal axis 500 and whose mutual distance defines the longitudinal length of the frame 5. On this regard, such a length may vary depending on the size of the electric motor 1. Also, the shape of the transversal section (namely the section considered on a plane orthogonal to the longitudinal axis 500) of the frame 5 may vary as a function, for example, of the installation for which the electric motor is designed. The transversal section may have a rectangular shape, more may be a square shape, with four blunt corners C1, C2, C3, C4 (see for example FIGS. 1, 1A, 2, and 2A). This means the frame 5 includes four main external surfaces 51, 52, 53, 54 that lay on planes two by two parallel.

The electric motor 1 also includes a stator assembly 2 and a rotor assembly 30. According to a solution known per se, the stator assembly 2 is arranged, at least partially, in a longitudinal cavity 5′ (indicated in FIGS. 1A and 2A) defined by the extruded body of the frame 5. The rotor assembly 30 is arranged in a cylindrical longitudinal space defined by the stator assembly 2. The configuration of the stator assembly 2 and/or the rotor assembly 30 are not relevant for the present disclosure. A skilled person is aware of possible configurations that such assemblies may assume in this kind of electric motors.

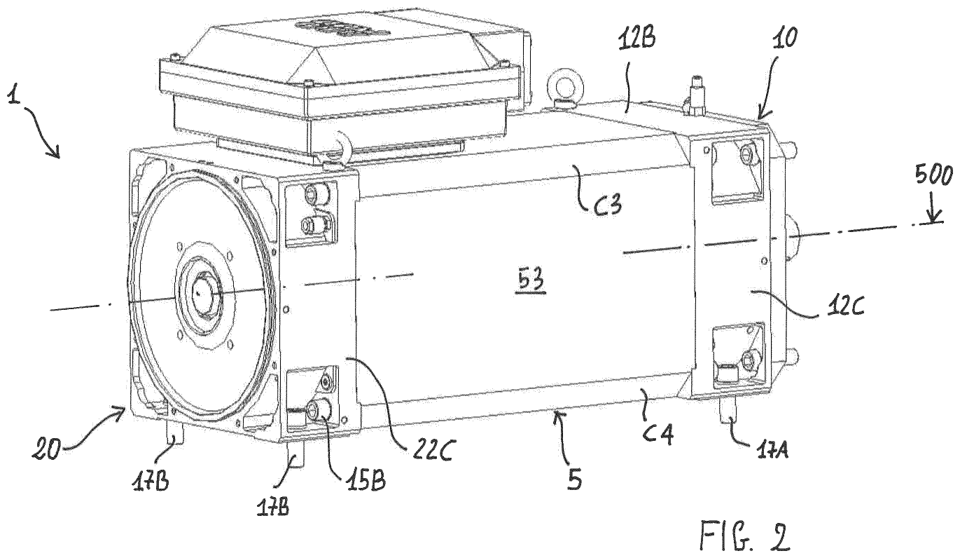

In any case, the rotor assembly 30 includes a rotor 3 which is supported, at opposite terminal parts 31A-31B, by the endshields 10, 20 so as to rotate about the longitudinal axis 500. More precisely, the rotation is allowed by bearing means 35A-35B (see FIGS. 3 and 3A) interposed between a corresponding terminal part 31A, 31B of the rotor 3 and a corresponding of said endshields 10, 20. A drive end 3A of the rotor 3 protrudes outside one of the two endshields to be connected to transfer the rotary force (torque) to an external device, system or mechanism, according to a solution known per se. In the Figures, the endshield from which the drive end 3A protrudes is indicated with the reference 10 and with the acronym DE 10 in the present description. Instead, the other endshield, opposed to the DE, is indicated with the reference number 20 in the figures and with the acronym NE 20 in the present description.

The electric motor 1 includes first connecting means 15A and second connecting means 15B for connecting the DE 10 and the NE 20, respectively, to a corresponding end surface 5A-5B of the frame 5. In the embodiment shown in the Figures, the DE 10 is connected to the first surface 5A by first connecting means 15A and the NE 20 is connected to the second surface 5B by second connecting means 15B (see for example FIGS. 1, 2, 3, 3A). More in detail, both the connecting means 15A-15B (first and second) include a plurality of axial bolts longitudinally screwed in the frame 5, namely according to a direction parallel to the longitudinal axis 500.

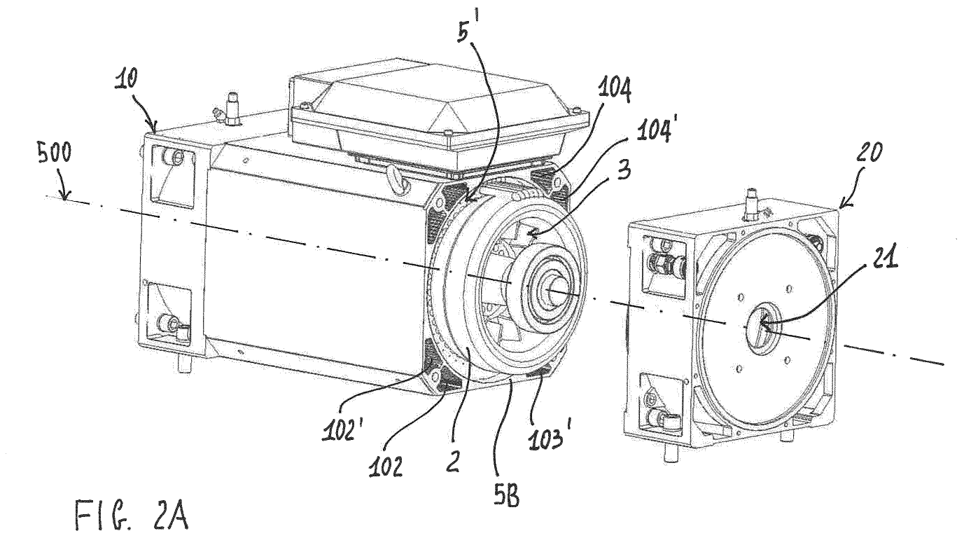

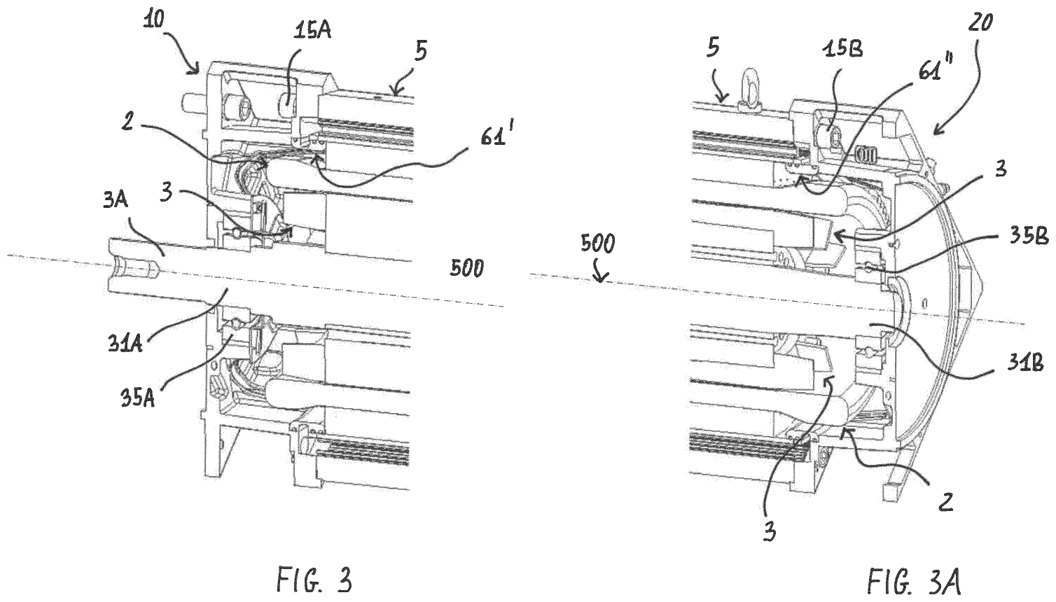

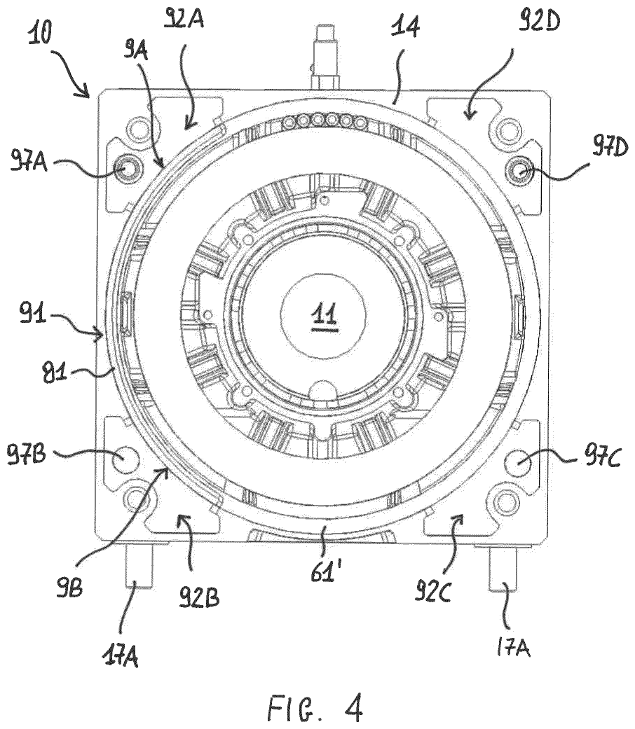

Each of the two endshields (DE 10, NE 20) includes a body with an internal cavity 11, 21 (see FIGS. 4 and 5) in which corresponding bearing means 35A, 35B are arranged to support the rotor 3, as above indicated (see FIGS. 3 and 3A). More precisely, at least the internal cavity 11 of the DE 10 develops through the entire axial length thereof to allow the drive end 3A of the rotor 3 to protrude outside (see FIGS. 1, 3, and 10 in combination).

Each of the endshields DE 10, NE 20 further includes a transversal coupling surface 14, 24 which is stably in contact with a corresponding end surface 5A, 5B of the frame 5 due to the fixing action of the corresponding connection means 15A, 15B. For this purpose, each of the transversal coupling surfaces 14, 24 develops on a plane orthogonal to the longitudinal axis 500. A sealing element (not shown in the Figures) is placed between the transversal coupling surface 14, 24 of each endshields 10, 20 and the corresponding end surface 5A, 5B of the frame 5. The sealing element (for example made of paper for seals) has the purpose to seal off, at the endshields 10, 20, the liquid cooling means provided for cooling the electric motor 1.

According to a possible embodiment, the two endshields 10, 20 have a prismatic shape defined by four side external surfaces 12A, 12B, 12C, 12D-22A, 22B, 22C, 22D that develop on planes two by two parallel. For each of the two endshields 10, 20, each external surface 12A, 12B, 12C, 12D-22A, 22B, 22C, 22D develops on a plane that is parallel to one on which an external surface 51, 52, 53, 54 of said frame 5 develops.

In the embodiment shown in the Figures, the first connecting means 15A include four axial bolts each of which arranged at a corner of the first end surface 5A of the frame 5 and of the corresponding transversal surface 14 of the DE 10. A similar solution is provided, mutatis mutandis, also for the second connecting means 15B that connects the second end surface 5B to the transversal surface 24 of the NE 20. However, a different number of bolts could be provided for the first connecting means 15A and for the second connection means 15B.

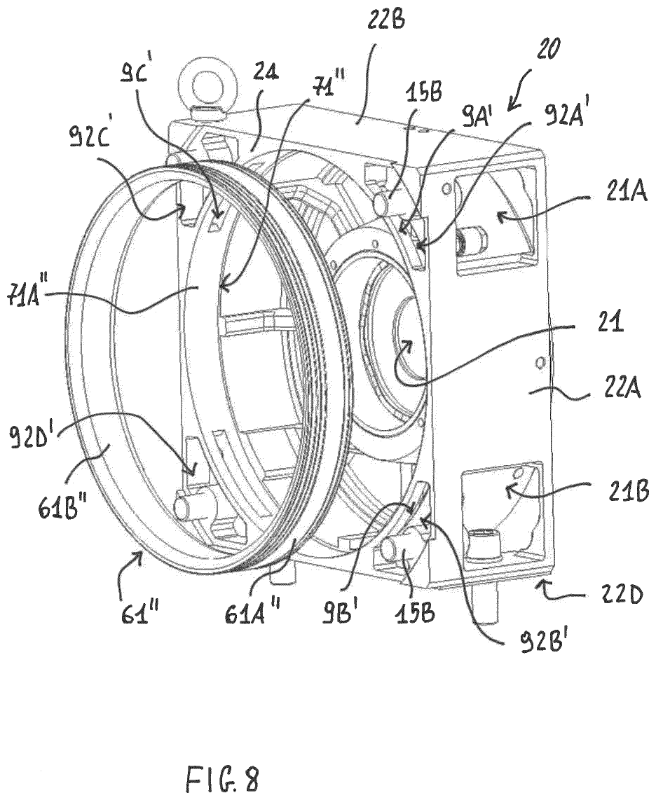

As shown in FIGS. 10-12, the DE 10 includes four external open cavities 11A, 11B, 11C, 11D each of which defined at one of its corners, wherein each corner is identified by two external surfaces 12A, 12B, 12C, 12D of the DE 10 lying on orthogonal planes. These cavities 11A, 11B, 11C, 11D are provided for positioning the connecting means 15A (axial bolts) and, in the case, for positioning hydraulic connectors used to feed or to discharge the circulation channels 101, 101′, 102, 102′, 103, 103′, 104, 104′ of liquid cooling means as below described. Further, the cavities 11A, 11B, 11C, 11D may be advantageously used for arranging fixing means (for example fixing bolts 17A) useful for connecting the DE 10 to a surface and/or to another device.

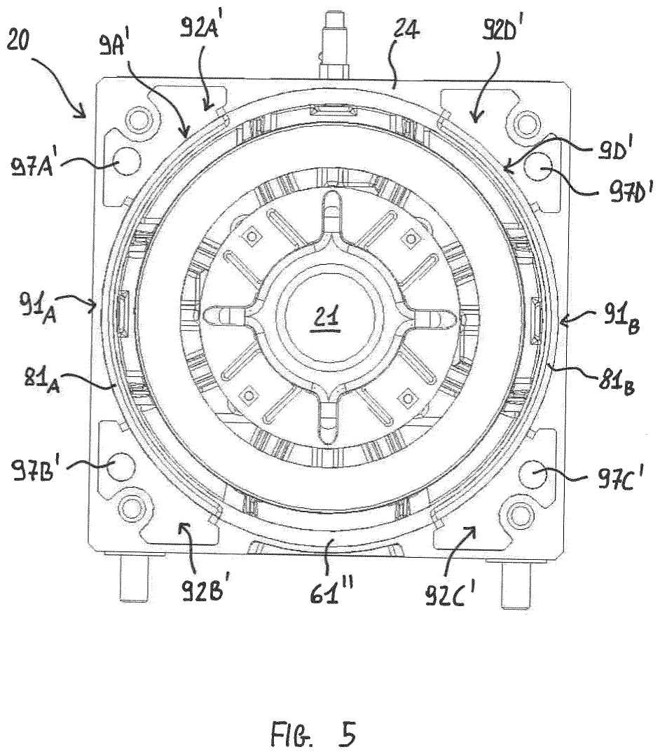

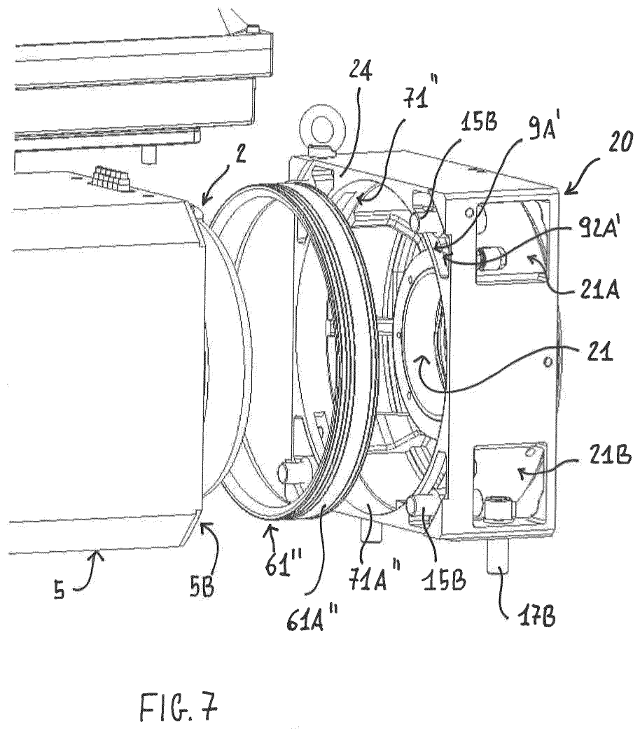

As shown in FIGS. 7-9 a similar solution is provided for NE 20 that includes four external open cavities 21A, 21B, 21C, 21D with a similar configuration of those provided for DE 10 and with the same purposes. On this regard, each of the external open cavities 21A, 21B, 21C, 21D is defined at one of the corners of the DE 20, wherein each corner is identified by two external surfaces 22A, 22B, 22C, 22D lying on orthogonal planes; further, each of the external open cavities 21A, 21B, 21C, 21D is opened on a corresponding side external surface 22A, 22C and on a surface opposite to the transversal coupling surface 24 of the NE 20. The external open cavities 21A, 21B, 21C, 21D are provided for positioning connecting means 15B, hydraulic connectors 151, 161, 171′, 171″ and/or fixing means 17B.

The electric motor 1 according to the disclosure includes liquid cooling means to dissipate heat generated during its operation. Such a cooling means include a plurality of circulation channels 101, 101′, 102, 102′, 103, 103′, 104, 104′ for the circulation of a cooling fluid, may be, but non exclusively, water. These circulation channels 101, 101′, 102, 102′, 103, 103′, 104, 104′ may be defined directly by the frame 5 so that the cooling liquid, flowing along the channels, exchanges heat directly with the frame 5.

These circulation channels 101, 101′, 102, 102′, 103, 103′, 104, 104′ may be axially oriented, i.e., they develop mainly along a direction parallel to the longitudinal axis 500. On this regard, the circulation channels 101, 101′, 102, 102′, 103, 103′, 104, 104′ may be defined during the extrusion process by means of which the frame 5 is obtained. Alternatively, they can be obtained by machining the frame 5, that is by drilling it longitudinally. As above, the frame 5 could be obtained by an extrusion process, a casting process or a 3D printing process or any other process suitable for the purpose.

According to an alternative embodiment (not shown in the Figures), the circulation channels can be defined by pipes inserted in corresponding longitudinal holes defined through the frame 5. In this case, the heat exchange between the cooling fluid and the frame is “indirect” due to the interface of the pipes along which the fluid flows.

In view of what above, for the purposes of the present disclosure the expression “circulation channel” wants generally to indicate a channel which crosses longitudinally (i.e., parallelly to the longitudinal axis 500) the frame 5 and along which the cooling fluid flows to exchange heat “directly” or “indirectly” with the frame in order avoid the overheating thereof.

In the embodiment shown in the Figures, the frame includes a first couple 101-101′, a second couple 102-102′, a third couple 103-103′, and a fourth couple 104-104′ of circulation channels wherein each of these couples is defined at a corresponding corner of the frame 5 as it can be seen in FIGS. 10-12 showing the end surface 5A of the frame 5 addressed to be connected to the contacting surface 14 of the DE 10.

For each of said couples of circulation channels 101-101′, 102-102′, 103-103′, 104-104′, the two channels are symmetrically arranged with respect to a radial plane 400 containing the longitudinal axis 500, wherein said radial plane 400 is a symmetric plane also for the corresponding corner C1, C2, C3, C4.

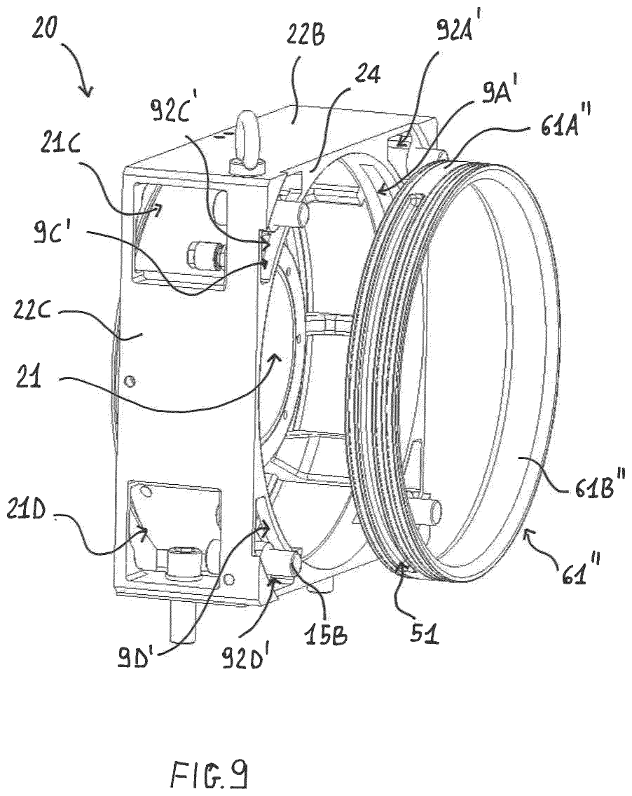

Always with reference to FIGS. 10 and 11, the transversal section (perpendicular to axis 500) of the circulation channels 101-101′, 102-102′, 103-103′, 104-104′ has a polygonal shape so as to occupy as much as possible the area of the corresponding corner, i.e. area of the transversal section comprised between the two external surfaces of the 51, 52, 53, 54 of the frame 5 identifying the corner C1, C2, C3, C4 and the internal cavity 5′ of the frame itself. This solution allows to increase the flow rate of the cooling liquid usable.

Further, as shown in FIG. 11, the circulation channels 101-101′, 102-102′, 103-103′, 104-104′ may be finned inwardly. This solution allows to increase the heat exchange surface with the cooling fluid. The fins can be easily obtainable by means of the extrusion process used to manufacture the frame 5.

According to the disclosure, the cooling means include at least a hydraulic connecting channel 91, 91_{A}, 91_{B} (see FIGS. 4 and 5) defined in one of the endshields 10, 20 for connecting hydraulically two of the circulation channels 101-101′, 102-102′, 103-103′, 104-104′. The expression “defined in” wants to indicate that the connecting channel is comprised in the space occupied by a corresponding endshields 10, 20, i.e. the space delimited by its external surfaces 12A, 12B, 12C, 12D, 22A, 22B, 22C, 22D. Further, for the purposes of the present disclosure, the expression “connecting channel” wants to indicate generally a “space” or a “conduit” in which the cooling fluid exiting from a circulation channel can flow up to the entry of another circulation channel, independently from the shape and of such a space/conduit.

According to the present disclosure, the hydraulic connecting channel 91, 91_{A}, 91_{B} includes at least a first section 81, 81_{A}, 81_{B} defined by the coupling of a collector element 61′, 61″ with a seat 71′, 71″ defined by the body of said one of the endshields 10, 20. In other words, the collector element 61′, 61″ and the seat 71′, 71″ are shaped so that the first section 81, 81_{A}, 81_{B} of the channel 91, 91_{A}, 91_{B} is defined only following their coupling.

Therefore, according to the disclosure, the hydraulic communication between two of said circulation channels 101-101′, 102-102′, 103-103′, 104-104′ is obtained by the coupling of at least two components (one of the endshields 10,20 and a collector element 61′, 61″) which are manufactured separately. This technical solution allows to simplify the machining of the endshields and consequently the costs and times for this operation. Further, this solution allows to increase the size of the hydraulic connecting channel and consequently to increase the cooling liquid flow rate.

According to an embodiment, shown also in the figures, the hydraulic connecting channel 91, 91_{A}, 91_{B} includes also a second section and a third section that make the first section 81, 81_{A}, 81_{B} communicating with a corresponding of said circulation channels 101-101′, 102-102′, 103-103′, 104-104′. In particular, the second section and the third section may be defined only by the structure of the corresponding endshields 10, 20.

According to an example embodiment shown in the Figures, the seat 71′, 71″ has an annular configuration and develops around the longitudinal axis 500. The seat 71′, 71″ may include a coupling surface 71A′, 71A″ whose shape is, at least partially, cylindrical developing around the longitudinal axis 500. The collector element 61′, 61″ is a ring-shaped body with an outer surface 61A′, 61A″ and an inner surface 61B′, 61B″ wherein the outer surface 61A′, 61A″ couples with the coupling surface 71A′, 71A″ of the seat 71′, 71″. When coupled with the seat 71′, 71″, the ring-shaped body 61′, 61″ (i.e., the collector element 61′, 61″) is coaxial with the longitudinal axis 500.

More precisely, the coupling surface 71A′, 71A″ of the seat 71′, 71″ and the outer surface 61A′, 61A″ of the ring-shaped body 61′, 61″ are shaped so as to define said first section 81, 81_{A}, 81_{B} of the connecting channel 91, 91_{A}, 91_{B}. The ring-shaped body 61′, 61″ may include at least one slot 51′, 51′_{A}, 51′_{B} that develops inwardly (i.e. toward the longitudinal axis 500) from the outer surface 61A′, 61A″. Such a slot may have a U-shape, considered on a radial plane containing the longitudinal axis 500.

The slot 51′, 51′_{A}, 51′_{B} develops for a pre-stablished angular sector (angle α) around the longitudinal axis 500. This angular sector may be less than 180°, as an example the angle can be 120°. Therefore, in such an embodiment, the first section 81, 81_{A}, 81_{B} of the hydraulic connecting channel 91, 91_{A}, 91_{B} is delimited by the surfaces of said slot 51′, 51′_{A}, 51′_{B} and by the cylindrical coupling surface 71A′, 71A″ of the seat 71′, 71″ to which the outer surface 61A′, 61A″ of the ring-shaped body 61′, 61″ is coupled.

According to an alternative solution, not shown in the Figures, the outer surface of the ring-shaped body could be cylindrical while the coupling surface of the seat could be configured so as to define a slot which develops in the endshield body; such alternative solution is conceptually equivalent to the one shown in the Figures. In this alternative solution, the first section of the channel would be defined by the surface of the endshield slot and by the outer surface of the cylindrical ring-shaped body.

The FIGS. 7-9 are views showing the NE 20 and the ring-shaped body 61″ couplable with the seat 71″ of the same NE 20. As shown, the seat 71″ develops axially from the transversal coupling surface 24 of NE 20. This means, when the electric motor 1 is assembled, the ring-shaped body 61″ is adjacent to the end surface 5B of the frame 5. On this regard, FIG. 3A clearly shows the arrangement of the ring-shaped body 61″ with respect to the frame 5 and the seat 71″ of the NE 20.

According to an example embodiment, considering the NE 20, the second section and the third section of the connecting channel are configured by two cavities 92A′, 92B′, 92C′, 92D′ defined of the NE 20, each of which being hydraulically connected to at least one of the circulation channels 101-101′, 102-102′, 103-103′, 104-104′. Each of the cavities 92A′, 92B′, 92C′, 92D′ includes a corresponding opening 9A-9B-9C-9D that makes it communicating with the first section of the connecting channel.

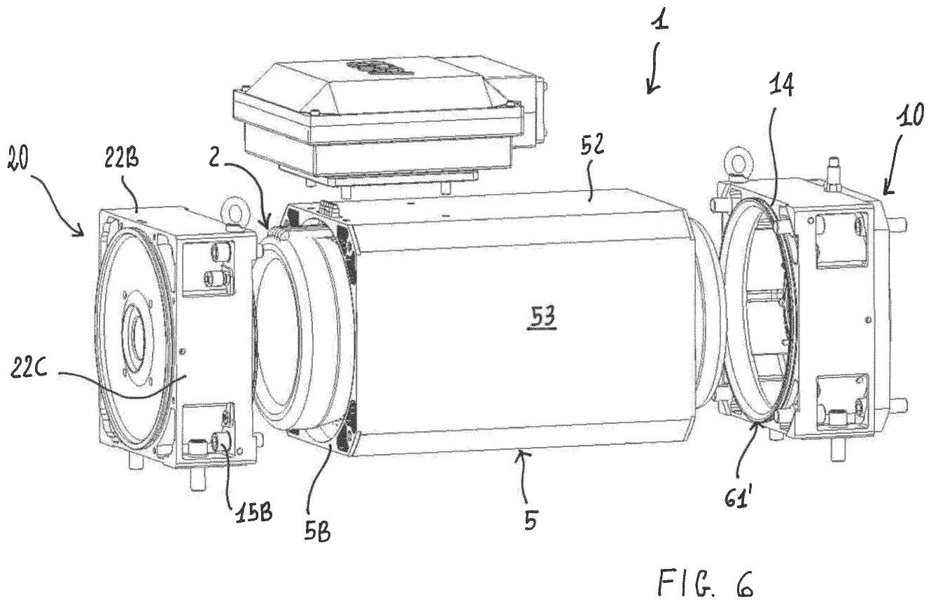

More precisely, in the FIGS. 7-9, the NE 20 includes four cavities 92A′, 92B′, 92C′, 92D′ each of which develops axially from the transversal coupling surface 24 of NE 20 (see FIG. 8). Each of these cavities 92A′, 92B′, 92C′, 92D′ is located a corner of the NE 20 so as to face a corresponding couple of circulation channels 101-101′, 102-102′, 103-103′, 104-104′ (see FIGS. 5 and 8). This allows the cooling fluid to flow from a cavity 92A′, 92B′, 92C′, 92D′ to the corresponding couple of circulation channels 101-101′, 102-102′, 103-103′, 104-104′ or vice versa.

Further, each of these cavities 92A′, 92B′, 92C′, 92D′ includes a corresponding opening 9A′, 9B′, 9C′, 9D′ at the coupling surface 71A″ of said seat 71″. The ring-shaped body 61A″ is coupled with said seat 71″ so that the first section 81_{A}, 81_{B} of the hydraulic channel 91, 91_{A}, 91_{B} communicates with two of the four cavities 92A′, 92B′, 92C′, 92D′ by means of the corresponding openings 9A′, 9B′, 9C′, 9D′. In other words, according to the disclosure, at least two of the above cavities 92A′, 92B′, 92C′, 92D′ of the NE 20 are made hydraulically connected by means of the first section 81_{A}, 81_{B} of the hydraulic channel 91_{A}, 91_{B} resulting from the coupling of the slot 51″ of the ring-shaped body 61″ with the coupling surface 71A″ of the seat 71″.

On this regard, in the embodiment shown in FIG. 5, at the NE 20, the ring-shaped body 61A″ is arranged in the seat 71″ so as to define two hydraulic connecting channels 91_{A}, 91_{B}. The two cavities 92A′ and 92B′ correspond to the second section and the third section of a first hydraulic channel 91_{A} being hydraulically connected by a first slot 51′_{A} of the ring-shaped body 61″. Analogously the two cavities 92C′ and 92D′ are hydraulically connected by a second slot 51′_{B} of the ring-shaped body 61″ defining the second section and the third section of a second hydraulic channel 91_{B}.

However, as below better clarified, the angular position of the ring-shaped body 61″, chosen for the arrangement in the seat 71″, determines which couple of cavities 92A′, 92B′, 92C′, 92D′ of the NE 20 become hydraulically connected via the first section 81_{A}, 81_{B} of a hydraulic channel 91_{A}, 91_{B}, wherein in any case such a first section is defined by the coupling of the ring-shaped body 61″ with the seat 71″ of the NE 20.

On this regard, looking in combination FIGS. 2A and 7, at the transversal coupling surface 24 of the NE 20, each cavity 92A′, 92B′, 92C′, 92D′ has a section geometrically corresponding to that of the cross section of the two circulation channels 101-101′, 102-102′, 103-103′, 104-104′ to which it faces. This solution optimizes the cooling liquid flow in both the directions.

Further, each cavity 92A′, 92B′, 92C′, 92D′ may include a service opening 97A′, 97B′, 97C′, 97D′ for the possible connection of a hydraulic connector 151, 161, 171′, 171″ useful to supply or to discharge the cooling liquid from the hydraulic circuit defined by the circulation channels 101-101′, 102-102′, 103-103′, 104-104′ and the hydraulic connecting channels 91_{A}, 91_{B} (see FIG. 5). When any hydraulic connector is not necessary, then such services openings 97A′, 97B′, 97C′, 97D can be closed by a plug element.

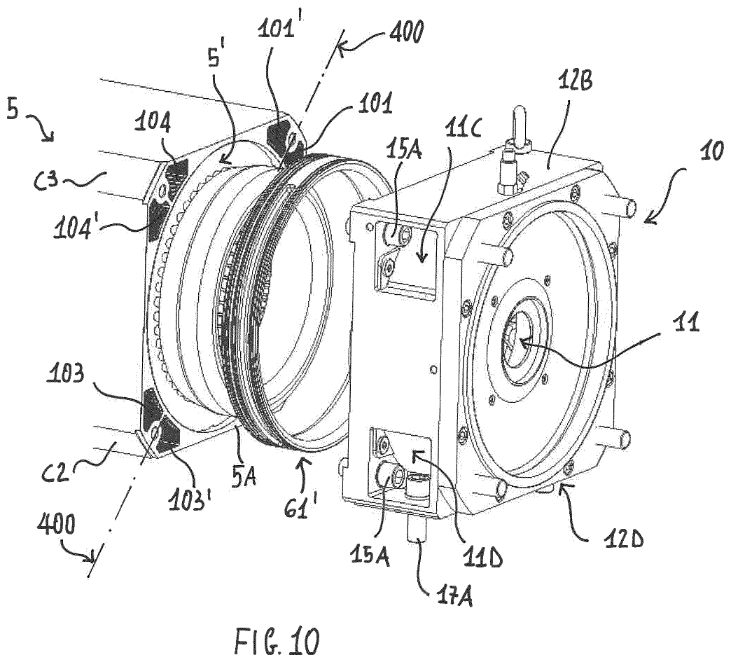

As shown in FIGS. 4 and 12, for the DE 10 the same technical solutions, just above disclosed, are provided. In particular, the DE 10 includes four cavities 92A, 92B, 92C, 92D, that develop from the transversal coupling surface 14 of DE 10, wherein each cavity faces a corresponding couple of circulation channels 101-101′, 102-102′, 103-103′, 104-104′. Further, for each cavity 92A, 92B, 92C, 92D of the DE 10, an opening 9A, 9B, 9C, 9D is provided in order to allow the hydraulic communication with the space defined by the coupling of the slot 51′ of the ring-shaped body 61′ with the seat 71′, namely with the first section 81 of a corresponding hydraulic connecting channel 91. Therefore, also for the DE 10, the second section and the third section of the hydraulic connecting channel 91 are defined by the corresponding cavities 92A, 92B, 92C, 92D.

As for the NE 20, also the cavities 92A, 92B, 92C, 92D of the DE 10 may include a service opening 97A, 97B, 97C, 97D for the same purposes above indicated (see FIG. 4).

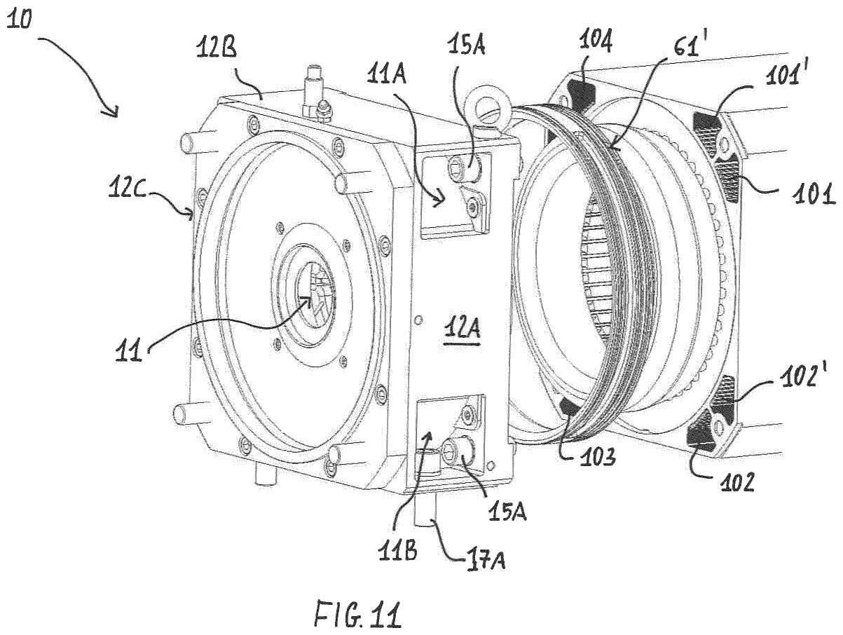

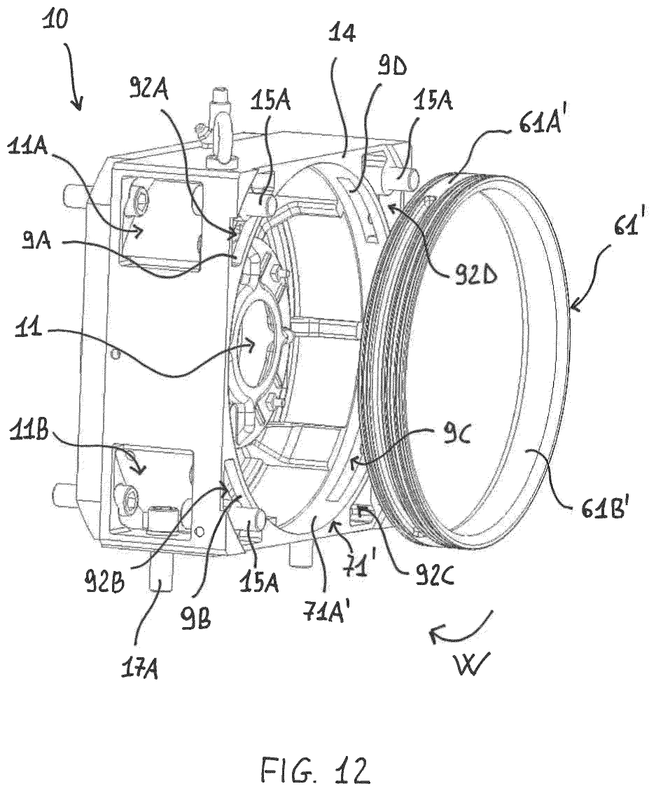

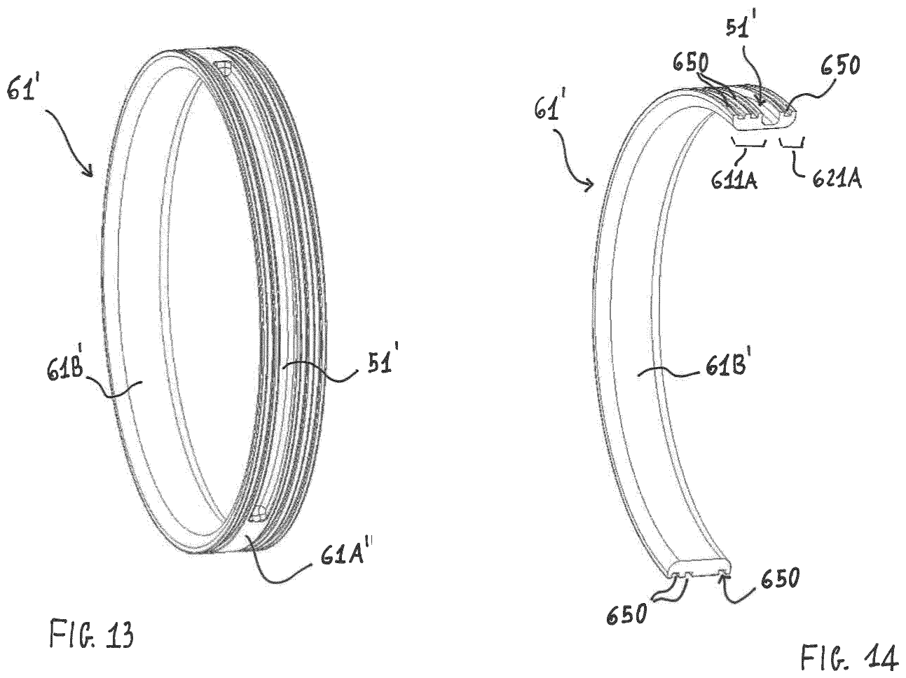

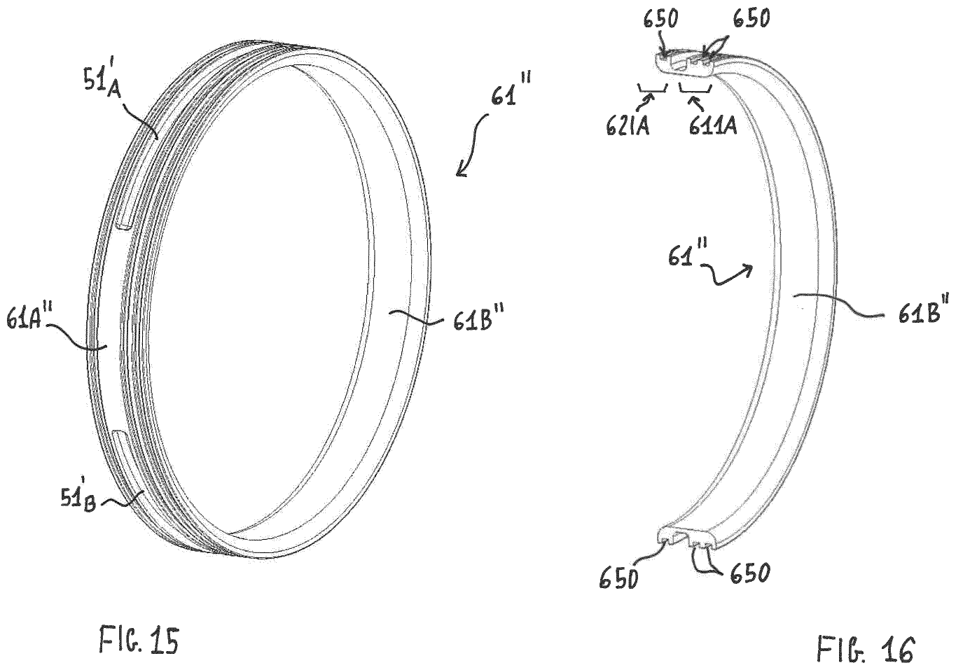

FIGS. 13-15 refer to possible embodiments of a ring-shaped body 61′,61″ couplable with a corresponding seat 71′, 71″ of a corresponding endshields 10, 20. In particular, in FIGS. 13 and 14 the ring-shaped body is indicated with the reference number 61′, while the one in FIGS. 15 and 16 is indicated with the reference number 61″. However, this indication does not want to limit in any way the use of the one of the illustrated ring-shaped body 61′, 61″ to a specific endshield (the NE 20 or the DE 10). In other words, each one of the two illustrated bodies 61′, 61″ could be installed in NE 20 or alternative in DE 10. Therefore, the ring-shaped body 61′, provided in the DE 10 in FIG. 4, could be installed in the NE 20, while the ring-shaped body 61″, provided in the NE 20 in FIG. 4A, could be installed in the DE 10. Further, for both of the endshields (10, 20), the same ring-shaped body (61′, 61″) could be provided.

In detail, in the embodiment shown in FIGS. 13 and 14, the ring-shaped body 61′ has a sole slot 51′ which develops from the outer surface 61A′ toward the inner surface 61B′.

In particular, the section view of FIG. 14 shows the U shape of the slot 51′. As shown, the outer surface 61A′ includes a first portion 611A and a second portion 621A which are separated by the slot 51′, at least along the angular sector along which it develops according to what above indicated. With reference in particular to FIG. 3, following the assembly of the electric motor 1, the portions 611A and 621A′ are located respectively close and distal with respect to the frame 5. Each of these portions 611A′, 621A′ includes at least a circumferential groove 650 which develops for an angle of 360 around the longitudinal axis 500. Such a groove 650 has the purpose to accommodate a sealing element (for example an O-ring) to seal the slot 51 and to avoid the exit of liquid from it).

As clearly illustrated in FIG. 14, the first portion 611A includes two (but they could be more) circumferential grooves 650 each of which to accommodate a sealing element. This increase the sealing effect on the part of the outer surfaces 61A′ that faces the surface of the longitudinal cavity 5′ of the frame 5 at the end of the circulation channels 101-101′, 102-102′, 103-103′, 104-104′, that is the part most subjected to the action of the cooling liquid (see FIG. 3).

According to the possible embodiment shown in FIGS. 15 and 16, the ring-shaped body 61″ includes two slots 51′_{A}, 51′_{B} symmetrically defined with respect to a diametral plane containing the axis of the body (longitudinal axis 500 when the electric motor 1 is assembled). These slots 51′_{A}, 51′_{B} have the same configuration of that shown in FIGS. 13 and 14 and above described. With reference to FIG. 5, when the ring-shaped body 61″ is coupled with the seat 71′, a first slot 51′_{A}, hydraulically connects a first cavity 92A′ with a second cavity 92B′, while a second slot 51′_{A}, 51′_{B} hydraulically connects the remaining cavities, namely the third cavity 92C′ and the fourth cavity 92D′.

Overall, in the NE 20 shown in FIG. 5 it is possible to identify a first connecting channel 91_{A} in which the first section 81_{A} is configured by the coupling of the ring-shaped body 61″ with the coupling surface 71A″ of the seat 71″, while the second section and the third section are respectively configured by the first cavity 92A′ and the second cavity 92B′. At the same time a second connecting channel 91_{B} is created, wherein the first section 81_{B} thereof is defined by the second slot 51′_{B} of the ring-shaped body 61″ coupled with said coupling surface 71A″. The third cavity 92C′ and the fourth cavity 92D′ define respectively the second section and the third section of this second connecting channel 91_{B}. According to the purposes of the present disclosure, each of these two connecting channels 91_{A}, 91_{B} hydraulically connects two couples 101-101′, 102-102′, 103-103′, 104-104′.

However, as above already, for both the endshields 10, 20 the hydraulic connections between the cavities 92A, 92B, 92C, 92D-92A′, 92B′, 92C′, 92D′ can vary depending on the angular orientation chosen for the ring-shaped body 61′,61″ when coupled with the corresponding seat 71′, 71″. For example, with respect to the condition shown in FIG. 5 or FIG. 12, if the ring-shaped body 61′ of NE 20 was rotated of an angle of 90° in the clock-wise direction (see arrow W in FIG. 12), then the first slot 51′_{A} would make the first cavity 92A′ and third cavity 92C′ hydraulically connected, while the second slot 51′_{B} would connect the second cavity 92B′ and the fourth cavity 92D′.

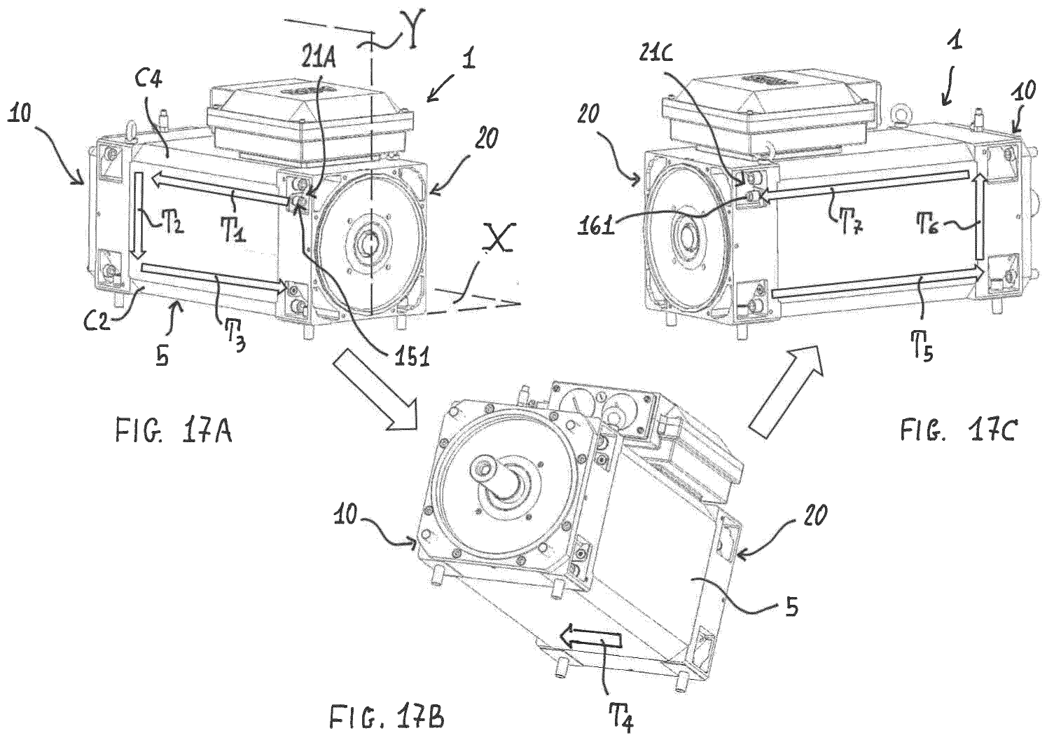

The use of an angularly adjustable ring-shaped body 61′,61″ having one slot or two slots, allows to configure one or more hydraulic circuit by means of which the electric motor 1 is cooled. As a fact, the angular positioning of the ring-shaped body 61′, 61″ determines the mode by means of which the frame 5 is cooled. On this regard, FIGS. 17A, 17B, and 17C refer a first cooling mode of the electric motor 1 shown in FIGS. 1 and 2.

In FIG. 17A, an installation plane X is indicated. With respect to such a plane X, the circulation channels 102-102′, 103-103′ are hereinbelow named “couples of bottom channels” since defined respectively along a corresponding bottom corner C1, C2. The other circulation channels 101-101′, 104-104′ are named “couples of upper channels” since defined along corresponding upper corners C3, C4 of the frame 5.

The NE 20 of the embodiment of FIGS. 17A, 17B, and 17C contains a ring-shaped body angularly adjusted so as to connect hydraulically the two couples of bottom channels 102-102′, 103-103′. For this purpose, the ring-shaped body 61″ of the NE 20 may have a sole slot. Indeed, the DE 10 contains a ring-shaped body 61′ having two slots according to what above disclosed and shown in FIGS. 15 and 16. In particular, the ring-shaped body 61′ of DE 10 is adjusted so that each of said two slots 51′_{A}, 51′_{B} hydraulically connects one channel of the couple of upper channels 101-101′, 104-104′, with a corresponding one of the bottom channels 102-102′, 103-103′defined on the same side with respect to reference plane Y, containing the longitudinal axis 500 and orthogonal to the installation plane X.

With reference to FIG. 17A, by means of a hydraulic inlet connector 151, at the NE 20 the cooling fluid is inserted in a first couple of upper channels (101-101′). Such a connector 151 is arranged in a corresponding of the external open cavity 21A provided by the structure of the NE 20. As shown by the arrows of FIG. 17A, the cooling fluid crosses longitudinally the frame 5 (arrow T1) so as to reach the DE 10 wherein it is diverted (arrow T2) by the ring-shaped body 61′ (in particular by a first slot 51′_{A}) to the entry of the of first couple of bottom channels (102, 102′). Then, the cooling fluid comes back to the NE 20 (arrow T3) to be diverted, by the corresponding ring-shaped body 61′, to the second couple of circulating bottom channels (103-103′) provided on the other side of the frame 5 (arrow T4 in FIG. 17B). With reference to FIG. 17C, the cooling fluid flows newly towards the DE 10 (arrow T5) wherein it is diverted to the second couple of upper channels (104, 104′) by a second slot 51′_{B} of the ring-shaped body 61′ provided in the DE 10 (see arrow T6). Finally, the cooling fluid comes back to the NE 20 (arrow T7) to exit by means of an outer hydraulic connector 161 arranged in a corresponding second external open cavity 21B of the NE 20.

Therefore, in the embodiment shown in FIGS. 17A, 17B, and 17C, in view of the configuration of the hydraulic circuit, the same flow rate of cooling fluid flows four times longitudinally along the frame 5.

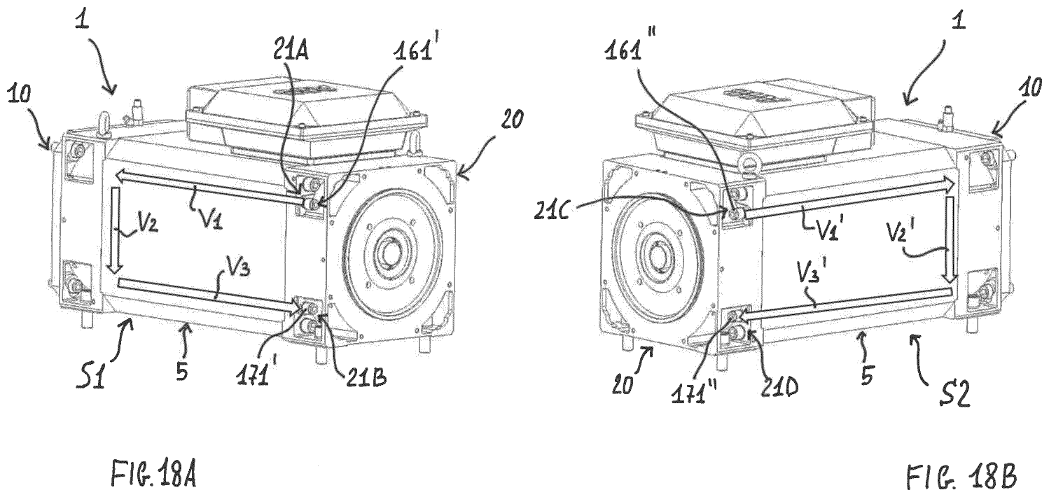

FIGS. 18A and 18B refer to a second cooling mode of the electric motor 1 of FIG. 1. Also in this case, the DE 10 contains a ring-shaped body 61′ having two slots 51′_{A}, 51′_{B} and adjusted with the same purposes above indicated for the solution of FIGS. 17A, 17B, and 17C. Instead, the NE 20 contains a ring-shaped element without any slot so as to avoid any hydraulic communication between the couples of circulation channels (both upper and bottom). This solution results in two hydraulic circulation circuits each of which defined on a side of the frame 5. These circuits are symmetric with respect to the plane Y above defined.

The arrows (V₁-V₂-V₃ and V₁′, V₂′, V₃′) in FIGS. 18A and 18B clearly show the fluid circulation direction in the two circuits. As shown, for each of the two sides (indicated with S1 and S2) of the frame 5, a hydraulic inlet connector 161′-161″ is arranged at an upper external open cavity 21A, 21C of the NE 20, while a hydraulic outlet connector 171′, 171″ is arranged at a bottom external open 21B, 21D of the NE 20. In this case, for each of the circuits, the cooling fluid flows twice longitudinally along the frame 5.

In view of what above, the use of the ring-shaped body above (with none, one or two slots) allows to configure different cooling modes depending on the installation, the space available for hydraulic connections and the operative conditions required to the electric motor. In particular, depending on the cooling circuit

The electric motor, according to the disclosure, can be easily realized at industrial levels. Thus, it can be easily manufactured at competitive costs with similar installations of the state of the art.

1. A liquid cooled electric motor comprising:
a frame that develops along a longitudinal axis;
a first endshield and a second endshield connected at opposite ends of said frame;
a stator assembly and a rotor assembly wherein said stator assembly is arranged, at least partially, in a longitudinal cavity of said frame and wherein said rotor assembly is arranged, at least partially, in a longitudinal space defined by said stator assembly and supported, at opposite ends, by said endshields so as to rotate about said longitudinal axis; and
a liquid cooling means to dissipate a heat generated during an operation of said electric motor, wherein said cooling means comprises a plurality of circulation channels defined through said frame for the circulation of a cooling fluid, and at least one hydraulic connecting channel sized to connect hydraulically two of said circulation channels at one of said endshields,
wherein the at least one hydraulic connecting channel comprises at least a first section configured by a coupling of a collector element with a seat defined by said one of said endshields.

2. The electric motor according to claim 1, wherein said at least one hydraulic connecting channel comprises a second section and a third section, wherein said first section is comprised between said second section and said third section, and wherein said second section and said third section make said first section communicating with a corresponding of said circulation channels.

3. The electric motor according to claim 1, wherein said seat has a coupling surface that develops around said longitudinal axis, wherein said collector element has a ring-shaped body with an outer surface and an inner surface, wherein said outer surface couples with said coupling surface of said seat, and wherein said outer surface and said coupling surface are shaped so as to configure said first section of said hydraulic connecting channel following their coupling.

4. The electric motor according to claim 3, wherein said ring-shaped body comprises a slot that develops from the outer surfaces along an angular sector around said longitudinal axis and wherein said first section of said hydraulic connecting channel is configured by the coupling surface of the seat and by the surfaces defining at least one slot of said ring-shaped body.

5. The electric motor according to claim 2, wherein said second section and said third section are defined by two cavities of said one of said endshield, wherein each cavity communicates with at least one of said circulation channels, and wherein at least two of said cavities comprises a corresponding opening that makes the corresponding cavity communicating with said first section of said hydraulic connecting channel.

6. The electric motor according to claim 16, wherein said opening is defined at the coupling surface of said seat, and wherein said ring-shaped body is coupled with said seat so that said slot communicates with two of the cavities by the corresponding openings.

7. The electric motor according to claim 4, wherein said ring-shaped body comprises two slots symmetrically defined with respect to a diametral plane containing said longitudinal axis, wherein when said ring-shaped body is coupled with the seat, a first slot hydraulically connects a first cavity with a second cavity and a second slot hydraulically connects a third cavity and a fourth cavity.

8. The electric motor according to claim 4, wherein said outer surface of said ring-shaped body comprises a first portion and a second portion which are separated by said at least one slot, at least along the angular sector along which it develops, wherein each of said portions comprises at least one circumferential groove which develops for an angle of 360° around the longitudinal axis, wherein the at least one groove accommodates a sealing element.

9. The electric motor according to claim claim 8, wherein said first portion is closer to said frame than said second portion and wherein said first portion comprises two or more circumferential grooves each of which to accommodate a sealing element.

10. The electric motor according to claim 1, wherein said frame has a rectangular shaped cross section, and wherein said cross section is considered on a plane orthogonal to said longitudinal axis.

11. The electric motor according to claim 1, wherein at least one of said endshields has a prismatic shape defined by four side external surfaces that develop on planes two by two parallel.

12. The electric motor according to claim 11, wherein said at least one of said endshields comprises four external open cavities each of which defined at one of its corners, wherein each corner is identified by two external surfaces of the endshield, wherein said open cavities accommodate connecting means to connect said frame to the endshield and/or to connect a hydraulic connector to feed or to discharge the cooling fluid flowing in said circulation channels.

13. The electric motor according to claim 1, wherein said frame is obtained by an extrusion process and wherein said circulation channels are defined by means of the extrusion process.

14. The electric motor according to claim 10, wherein said plurality of circulation channels comprises a first couple, a second couple, a third couple, and a fourth couple of circulation channels wherein each of these couples is defined at a corresponding corner of said frame.

15. The electric motor according to claim 14, wherein for each of said couples of circulation channels, the corresponding two channels are symmetrically arranged with respect to a radial plane containing said longitudinal axis, and wherein said radial plane is a symmetric plane also for the corresponding corner.

16. The electric motor according to claim 4, wherein said at least one hydraulic connecting channel comprises a second section and a third section, and said second section and said third section are defined by two cavities of said one of said endshield, wherein each cavity communicates with at least one of said circulation channels, and wherein at least two of said cavities comprises a corresponding opening that makes the corresponding cavity communicating with said first section of said hydraulic connecting channel.

17. The electric motor according to claim 11, wherein said plurality of circulation channels comprises a first couple, a second couple, a third couple, and a fourth couple of circulation channels wherein each of these couples is defined at a corresponding corner of said frame.

18. The electric motor according to claim 17, wherein for each of said couples of circulation channels, the corresponding two channels are symmetrically arranged with respect to a radial plane containing said longitudinal axis, and wherein said radial plane is a symmetric plane also for the corresponding corner.

19. The electric motor according to claim 13, wherein said plurality of circulation channels comprises a first couple, a second couple, a third couple, and a fourth couple of circulation channels wherein each of these couples is defined at a corresponding corner of said frame.

20. The electric motor according to claim 19, wherein for each of said couples of circulation channels, the corresponding two channels are symmetrically arranged with respect to a radial plane containing said longitudinal axis, and wherein said radial plane is a symmetric plane also for the corresponding corner.
